(19) United States
(12) Patent Application Publication
(10) Pub. No.: US 2025/0111088 A1
(43) Pub. Date: Apr. 3, 2025

(54) Personal Security Method to Establish and Preserve Pseudonymity of a Writer

(71) Applicant: Duquesne University of the Holy Spirit, Pittsburgh, PA (US)

(72) Inventor: Patrick M. Juola, Pittsburgh, PA (US)

(73) Assignee: Duquesne University of the Holy Spirit, Pittsburgh, PA (US)

(21) Appl. No.: 18/899,703

(22) Filed: Sep. 27, 2024

Related U.S. Application Data
(60) Provisional application No. 63/541,359, filed on Sep. 29, 2023.

(51) Int. Cl. G06F 21/62; G06F 40/174

(52) U.S. Cl. CPC G06F 21/6254; G06F 40/174

(57) ABSTRACT

The present invention is a personal security method and a writer's tool, in two or three modules, that assures generation of text by a user which cannot be identified has having been written by said user. The present invention uses Large Language Modules (LLMs such as but not limited to ChatGPT) principally to generated the document. Using an LLM together with the two or three modules of the present invention side-steps the author's (user's) features entirely by having the LLM generate the text, creating an authorship opaque document, and thus concealing and securing the identity of the writer.

### FIELD OF THE INVENTION

The present invention is a personal security tool for writers, to allow generation of a writing while preserving the pseudonymity of its author—thus guarding against authorship attribution technologies that could otherwise uncover the identity of the author (sometimes with disastrous results).

### BACKGROUND OF THE INVENTION

“Authorship attribution” is an active research area in which the authorship of a document is inferred from the style in which the document is written. (For example without limitation, when an author dates a document, “Aug. 28, 2023,” this date convention marks this author as American, not British, because such a date convention is used exclusively in the United States.) Because ordinarily written documents contains these distinctive marks of its author, the author's identity can be revealed against the author's wishes, as in the case of a whistleblower who wishes to remain pseudonymous/anonymous for their own safety. These “marks” (typically called “features”) are well known in the authorship identification technologies, and include without limitation word choice patterns, average word length, average sentence length, punctuation selection and frequency, and many other distinguishing characteristics that can be used to distinguish authors. Typically, any given author is not able to mask his or her own identity by consciously attempting to write in a different or altered style—authorship identity is virtually if not completely like a fingerprint, unique to every individual writer. Therefore, at this writing a technology to conceal this authorship-attribution fingerprint is heretofore unknown. A need remains for a technology to empower a writer to generate a writing—of any length, short or long—for which authorship attribution software is rendered incapable of identifying its authorship, thus preserving the pseudonymity/anonymity of the author as needed or desired.

### BRIEF DESCRIPTION OF THE INVENTION

In order to meet this need, the present invention is a personal security method to establish and preserve the pseudonymity of a writer, accomplished with a computer-based writer's tool for generating text that cannot be identified, by its features, as having been written by a particular or individual author. The present invention uses Large Language Models (LLMs) such as ChatGPT to write the document-which thus side-steps the author's features entirely by having the LLM generate the text, creating an authorship-opaque document, particularly WHEN the LLM is used in such a way so as not to inject or re-inject the human author's features while interacting with the LLM. (An author's features are assessed by “stylometrics,” or the study of authorship features.) Also, inasmuch as LLM text generation typically generate inaccurate facts, it is particularly important that a pseudonymous writer edit and fact-check an LLM generated document without introducing or re-introducing the individual's features during the fact-checking process. The present invention, in one embodiment, therefore includes three modules that preserve and perpetuate the pseudonymity of the document's writer author—1) an optional chatbot prompt stylometrics alert module; 2) a text compiling module; and 3) an objective editing module, all embodied in an LLM interfct technology that does NOT allow the LLM to “see” the first module at all, and reduces or eliminates any ability of the LLM to assimilate the user's features at any time. In other words, the instant writer's tool, with its two or three distinctive modules, is designed to be deployed alongside and in coordination with an LLM, to govern and control the output of the LLM to preserve the pseudonymity of the writing produced by the LLM. In particular, the first and third modules reduce or eliminate introduction or reintroduction of the author's features into the LLM process, and the middle module—the second module—automatically removes the text passages containing prompts providing by the user to the the LLM (typically in the form of chatbot prompts) if present. The three modules operate in the sequence above described. With a robust LLM and the (minimum) two or three module tool of the present invention, it is now possible to generate a desired document, with an LLM, that remains opaque a to the identity of the individual ccooperating with the LLM to produce the document.

### DETAILED DESCRIPTION OF THE INVENTION

The entire world is fascinated, particularly right at the moment, with the advantages and perceived dangers of Large Language Models (LLMs), such as ChatGPT, in part because LLMs are aspects of Artificial Intelligence that individuals believe they can choose to interact with (as opposed to, say, predictive search texts in search engine search statements, which tend to appear without choice or request and garner scant attention). Less widely known at this writing is: those who work with LLMs quickly learn not only how interactive they are, but how evolutionary they are—embodying constant machine learning to expand, shift and evolve—which can by definition include adopting stylometrics from the “dialogue” with the user. For example, a typical interaction with ChatGPT usually includes user-driver “chatbot prompts” that initiate a back-and-forth text generation exchange having to do with a concrete subject, such as “Who are the current leaders in interplanetary telescopy?” and “Whar have these leaders published during [date range]?” Such chatbot prompts would predictably cause the LLM to generate objective language (subject, verb object) describing the current state of affairs (who, what, where, when) of interplanetary telescopy. However, already at this writing “chatbot prompts” often do embody stipulations as to writing style, such as “Please keep the tone casual,” or “Please summarize more briefly,” and so forth. Most document generation by LLM is thus initially a conversational “dialogue” between the use and the chatbot (or LLM interface, whatever it may be) so that the text generated contains both the chatbot prompts and the text generated by the LLM in response to the prompts. As this document-generation back-and-forth interaction goes forward, and because of the machine-learning underpinnings of LLM, one must accept as a given that LLMs such as ChatGPT are positioned at the front lines of adopting the features of a ChatGPT user (certainly collectively, and even individually), so any stylometric-revealing requests by the user will presumably be assimilitated into the machine learning of the LLM. Further to illustrate this “assimilation” dynamic, LLM users learn early on that they must never reveal traditional “personal information” to a chatbot or LLM—because the LLM will absorb and perpetuate it. It is therefore equally ideal—and addressed by the present invention—to avoid revealing the personal features of an individual author, during the chatbot-prompted LLM text generation dialogues, lest those features re-appear in otherwise LLM generated text(s). The present invention is therefore a personal security tool that harnesses the ability of an LLM to generate text free of the features of a user, using certain required and optional ways of preventing the user's introducing or re-introducing his or her own features during the user's interaction with the LLM (and also, of course, by harnessing the ability of the LLM to generate non-author-specific text in the first place).

The above-described non-introduction of features is accomplished in part with the (optional) first of three modules of the present invention, namely, the optional “chatbot prompt stylometrics alert module.” This module contains and deploys a protocol of prompts by which an LLM user is urged (not required) to adhere to concrete subject matter requests without revealing stylometric tendencies. The chatbot prompt stylometrics alert module of the present tool therefore embodies certain “discouragement” flags (not outright proscriptions) for the user's initial LLM interaction. Specifically, the opacity module creates an alarm event (a colored marker, a sound, a pop-up text box, a symbol, or other alert) any time the user includes any of the following (exemplary, not limiting) terms it its chatbot prompts prior to execution: “simple, shorter, clearer, tone, emphasis, sophistication, longer, elaborate, impressive) and so forth. The module itself includes many many more terms of this nature, meant to “flag” when a user is (perhaps inadvertently) specifying style more so than direct content of a writing—the above examples are illustrative and non-limiting. The chatbot prompt stylometrics alert module does not prohibit any particular textual interaction—the module FLAGS possible features revelations, so that the user can then pre-emptively edit them and thus avoid revealing the user's features to the LLM. This first module is thus designed to monitor text-input in draft before the user “hits enter,” or prior to execution so that the LLM remains completely uninformed as to either the draft prompt language or the trigger of the alert (with the LLM's therefore not participating in this first module at all). The user can override the alert, which override can be necessary for many reasons—such as concrete subject matter in which certain vocabulary is contextually relevant to the subject matter and has nothing to do with suggested writing style. By deploying and following the first optional module, the user minimizes or eliminates any disclosure of the user's features to the LLM

The second module of the present tool is the text collecting tool. This module literally amasses the text generated by the LLM and creates a file containing the text, for analysis by the third module (described below). The text collecting tool takes the back-and-forth between the user and the chatbot (or other LLM dialogue in any format) and removes all the user prompts, leaving only the LLM generated text—typically in paragraph form.

The third module of the present tool is the objective editing module. The objective editing module automatically renders the formatted text of the second module as a checklist-worksheet for fact-checking, specifically calling out every recitation in objective language, individually, as well as every citation to prior literature or publications of any kind. This automatically generated fact checking worksheet accomplishes two goals—the tool identifies the asserted facts in the LLM-generated writing that need verification AND the fact checking worksheet provides a concrete editing guide in which facts are checked while the individual LLM user is effectively discouraged from document editing in such a way that could inadvertently reintroduce the individual's own features. This third module of the invention literally generates an editing worksheet (electronic, paper, or any other interactive form) for the user to fill out. Because only the generated check-boxes or fill-in-the-blank-type lines generated in the worksheet (for inserting correct citations, for example) may be added to or modified without the user's receiving further alerts (see the first module for the description of the alert type possibilities), the worksheet interaction tool prevents the user from inadvertently revealing the user's features by making any edits OTHER than objective (fact-directed) edits, during the document editing process. By preserving pseudonymity, a writer can avoid harmful physical and legal pitfalls that would otherwise appear, when pseudonymity is required. (A comment is in order regarding the concept of “pseudonymity.” For the purposes of the present invention, pseudonymity embraces anonymity, but in the modern world there is virtually no such thing as anonymity any more, if there ever was. When an author wishes not to be identified, as a practical matter that author typically if not always adheres to pseudonymity, particularly because an assertion of “anonymity” only inflames any wish to uncover the authorship desired to be concealed. For the practical purpose of the present disclosure and claims, however, anonymity should be understood to be subsumed within the concept of pseudonymity.)

Rendering the sequential algorithm for the three modules to approach mathematical (executable) terms, the invention may be envisioned as machine language, executed by a computer with interaction by a user, to accomplish a personal security method as well as a writer's compositional pseudonymity tool, embracing the steps of the following three exemplars for each of the three modules:
1) Given a prescribed set of flag codes or truncation thereof (wherein h, i, j, k, l, m, n, o, p . . . correspond to simple, shorter, clearer, tone, emphasis, sophistication, longer, elaborate, impressive . . . ) automatically screen each of a sequential series of text prompts (a, b, c, d . . . ) for the presence of one or more flag codes or truncations thereof (h, i, j, k, l, m, n, o, p) and generate a flag or other alarm when present, prior to execution of said text prompt to an LLM (this is the optional module); followed by
2) For each text prompt (a, b, c, d, . . . ) from module 1) resulting in text generation by an LLM, cull all text generated by the LLM while removing each text prompt (a, b, c, d . . . ) to yield a culled text; and
3) Convert the culled text from module 2) to a fact-discerned worksheet, by assessing each segment of the culled text in module 2) to segregate all statements of fact, identified by their language syntax or by format of a literature citation, to generate a question-and-answer type worksheet identifying each statement of fact or literature citation, to enable user interaction for fact checking while structurally discouraging any other document editing during fact checking.

Although the invention has been described above with particularity, with specific reference to aspects of the instant technology, the invention is only to be limited insofar as is set forth in the accompanying claims.

I claim:

1. A personal security method for establishing and maintaining the pseudonymity of an author containing at least two modules, comprising executing, in a module, a back-and-forth user interaction with a Large Language Module (LLM) using one or more user prompts, to generate a dialogue in any format, and collecting said dialogue with a text collecting tool and removing all said user prompts to generate an LLM generated text; followed by populating a separate objective editing module with said LLM generated text, to create an editing worksheet for completion by a user, wherein said editing worksheet contains one or more input possibilities only for fact-insertion or fact-editing by said user; with a final step of instructing said LLM to generate a text solely from said editing worksheet module, to render a document for which pseudonymity has been established and maintained due to the limited interaction of the user and the constraints of the recited modules.

2. A personal security method for establishing and maintaining the pseudonymity of an author containing at least three modules, comprising executing, in a first module, a series of flag codes regarding input of a user; followed by, in a second module, a back-and-forth user interaction with a Large Language Module (LLM) using one or more user prompts, to generate a dialogue in any format, and collecting said dialogue with a text collecting tool and removing all said user prompts to generate an LLM generated text; followed by populating a third objective editing module with said LLM generated text, to create an editing worksheet for completion by a user, wherein said editing worksheet contains one or more input possibilities only for fact-insertion or fact-editing by said user; with a final step of instructing said LLM to generate a text solely from said editing worksheet module, to render a document for which pseudonymity has been established and maintained due to the limited interaction of the user and the constraints of the recited modules.

3. A personal security system and writer's tool comprising three modules for user interface with a Large Language Module (LLM), in executable form: a chatbot prompt stylometrics alert module; a text collecting tool module; and 3) an objective editing module, which three modules are deployed in sequence to create an LLM-generated document in which pseudonymity of a user is established and maintained.

4. The personal security system and writer's tool of claim 3, further wherein said first module contains a prescribed set of flag codes or truncations thereof wherein h, i, j, k, l, m, n, o, p, . . . correspond to one or more formatives including simple, shorter, clearer, tone, emphasis, sophistication, longer, elaborate, impressive . . . and is enabled automatically to screen input from a user for the presence, prior to any execution of said input by said user, of one or more formatives and to alert the presence of one or more said formatives, via flag code, by means of any of an alarm event selected from the group consisting of a color, a sound, a marker, a pop-up text box, a symbol, a light, and a vibration,

[symbol]

5. The personal security system and writers tool of claim 4, wherein said objective editing module further generates said editing worksheet in electronic, paper or any other interactive form with editing prompts therein (fill-in-the-blank content or check box content) and wherein said editing module and said editing worksheet prohibit any editing of said editing worksheet except for editing said editing prompts by said user.

6. The personal security and writer's tool of claim 5, wherein said LLM generated text from said second module is populated into said third module, with no additional text population to said third module.
